(19) United States
(12) Patent Application Publication
(10) Pub. No.: US 2013/0068695 A1
(43) Pub. Date: Mar. 21, 2013

(54) Methods and Compositions For the Prevention of Struvite Scale Formation In Wastewater Systems

(71) Applicants: Ronald Wardle, Findlay, OH (US); Mark Shand, Findlay, OH (US); Matthew P. Madolora, Austin, TX (US); Jerry Elliott Rademan, Jacksonville, FL (US)

(72) Inventors: Ronald Wardle, Findlay, OH (US); Mark Shand, Findlay, OH (US); Matthew P. Madolora, Austin, TX (US); Jerry Elliott Rademan, Jacksonville, FL (US)

(21) Appl. No.: 13/613,963

(22) Filed: Sep. 13, 2012

Related U.S. Application Data
(60) Provisional application No. 61/535,706, filed on Sep. 16, 2011.

(51) Int. Cl. C02F 1/68

(52) U.S. Cl. 210/697

(57) ABSTRACT

A blend of micro-crystals of magnesium ammonium phosphate and other seed materials with magnesium hydroxide slurries reduces struvite scale in wastewater collection systems leading into waste-water treatment plants. These “seeds” act as attractants to phosphates and ammonia to allow the seeds to grow and remain dispersed throughout the waste water system. This greatly minimizes, or prevents struvite scale from building up in unwanted areas such as pipes, pumps, and valves that could potentially cause water flow blockage.

### CROSS-REFERENCE TO RELATED APPLICATION

This application claims priority to and the benefit of U. S. Provisional Patent Application No. 61/535,706, filed on Sep. 16, 2011, the entire disclosure of which is incorporated herein by reference in its entirety

### BACKGROUND OF THE INVENTION

The present invention relates to the technical field of wastewater treatment, and more particularly, to the technical field of struvite scale prevention in wastewater treatment using magnesium bearing compounds.

Struvite is a mineral phosphate salt compound. For example, struvite is commonly referred to as Magnesium Ammonium Phosphate (MAP) or Ammonium Magnesium Phosphate (AMP). A chemical formula of MgNH₄PO₄-6H₂O and a specific gravity of 1.7 are commonly associated with such compound references. Within a wastewater system, such as a wastewater collection and treatment system, the components of struvite (e.g., Mg⁺², NH₄⁺ and PO₄⁻³) may exist. Sometimes these components may concentrate and precipitate to form struvite scale on pipes, valves, pumps, and other structures throughout the wastewater system. Unwanted scale build-up can lead to loss of process or equipment capacity, undesirable equipment or process downtime, and require significant manpower to clean, replace or otherwise overcome the consequences of scale build-up.

Magnesium hydroxide (e.g. a Mg(OH)₂ slurry) is often used in wastewater treatment to reduce odors, minimize corrosion and supply alkalinity into acid-generating biological treatment processes. Various magnesium salts, such as magnesium nitrate, magnesium chloride and magnesium sulfate can be added directly to biological wastewater treatment processes to help facilitate biological utilization of phosphorus. As the trend for increased phosphorus removal drives utilities to incorporate more biological processes specifically designed to remove phosphorus more efficiently and effectively, the potential for increased magnesium salt use and subsequent need for downstream processes to support waste streams with higher free phosphate concentrations and consequent scale-forming conditions increases as well. Because Mg⁺² is typically found to be a limiting reagent in the chemical formation of struvite, practical use of various magnesium compounds in wastewater treatment is frequently diminished by fear of potential struvite scale.

When the above mentioned scale-formation occurs, wastewater plant operators typically resort to the use of various organic acids, such as ascorbic or citric acid, or inorganic acids, such as hydrochloric or sulfuric acid, in an effort to dissolve the scale build-up. Or as a preventative measure, operators may employ one or more of a variety of chemical agents designed to sequester, chelate, reduce or remove one or all of the chemical components of struvite. Additionally, operators may attempt to mitigate one of the other factors that contribute to struvite formation such as: turbulence, pH spikes, high component concentrations, and temperature.

Although the above acid treatments can be effective in dissolving struvite scale that has formed, there are significant drawbacks. In many instances the acid treatment must be administered off-line, i.e., the process, equipment or conveyance system must be removed from service in order to be cleaned of scale. Acid treatments may also be considered on-line, and in situ. But such on-line treatments carry the added risk of destruction of alkalinity, and consequent destabilization of pH, which can lead to biological upset and/or process inefficiency. Preventative measures designed to remove one of the chemical components of struvite can lead to mineral and nutrient deficiencies within the biological system, or even lead to alternative types of scale, or unwanted sludge, rather than struvite. Moreover, because struvite has gained increasing attention as a valuable, nutrient rich fertilizer, many operators would prefer scale abatement methodologies that continue to allow recovery of the component minerals. The use of some metal salts, including Al, Fe or Ca can lead to the precipitation of unwanted sludge and render the prized nutrients/minerals unrecoverable for sale or unusable for agricultural purposes.

### SUMMARY OF THE INVENTION

The use of seeding materials, such as struvite crystals, can lead to reducing or eliminating the problematic nature of struvite scales. As a result, when used as an additive to magnesium bearing compounds, the potential formation of struvite can be controlled preferentially as a nutrient-rich suspended solid rather than precipitated as a scale.

In accordance with preferred embodiments of the present invention, the magnesia compound and the struvite seeds may be added in sufficient amounts, either as an admixture or in prescribed succession, to allow the magnesia to function in its prescribed role for odor or corrosion control, or as an alkalinity supplement while mitigating the potential for struvite formation in downstream processes.

After the Mg(OH)₂/Struvite passes through the water treatment process, the dispersed struvite crystals can then be collected (e.g., harvested) and processed as a nutrient rich sludge for many beneficial uses.

There are many benefits that can be derived from the use of Mg(OH)₂ and various magnesium salts in , for example, biological treatment systems. A method or composition is needed to allow a more varied and diverse array of applications for Mg(OH)₂ slurry. However, the potential consequences of struvite scale formation inhibits use of Mg(OH)₂. Embodiments of the present inventions addresses the potential formation of struvite scale, while using Mg(OH)₂ or MgO, or various magnesium salts for various wastewater treatment purposes, through the use of struvite seeds or other chemical additives.

In Concentrated, or Confined, Animal Feed Operations (CAFOs), the collection and treatment of waste streams is often mandated to reduce odor emissions and to prevent the pollution of surface and groundwater streams. Similar to the issues mentioned for municipal wastewater treatment, CAFO pollutant streams contain high levels of nitrogen and phosphorus bearing wastes, and the collection and subsequent treatment of such wastes can encounter struvite scale problems that can be similar to those found in municipal wastewater treatment. Embodiments of the present invention can be similarly to CAFOs for the prevention of struvite scale.

Landfill waste streams, more commonly leachates, are typified by the presence of putrescible organics, metals and low pH attributed to ongoing biological decomposition of wastes and a predominantly anoxic environment. These leachate streams may contain high levels of nitrogen and phosphorus bearing wastes, and the collection and treatment of such wastes, which may utilize Mg(OH)₂, can encounter struvite scale problems akin to those found in municipal wastewater treatment. Embodiments of the present invention can be applied to Landfills for the prevention of struvite scale.

### BRIEF DESCRIPTION OF THE DRAWINGS

FIG. 1 is a schematic depiction of a wastewater collection and treatment system.

FIG. 2 is a wastewater treatment system showing where Mg(OH)₂ is commonly applied, and outlines the most common areas Mg(OH)₂ is added within a wastewater collection and treatment system. Depending on dosage rates, chemical, biological, and physical factors, the addition of Mg(OH)₂ or other Mg salts.

FIG. 3 is a wastewater treatment system showing where Struvite Enhanced Mg(OH)₂ slurry may be applied.

### DESCRIPTION OF THE PREFERRED EMBODIMENTS

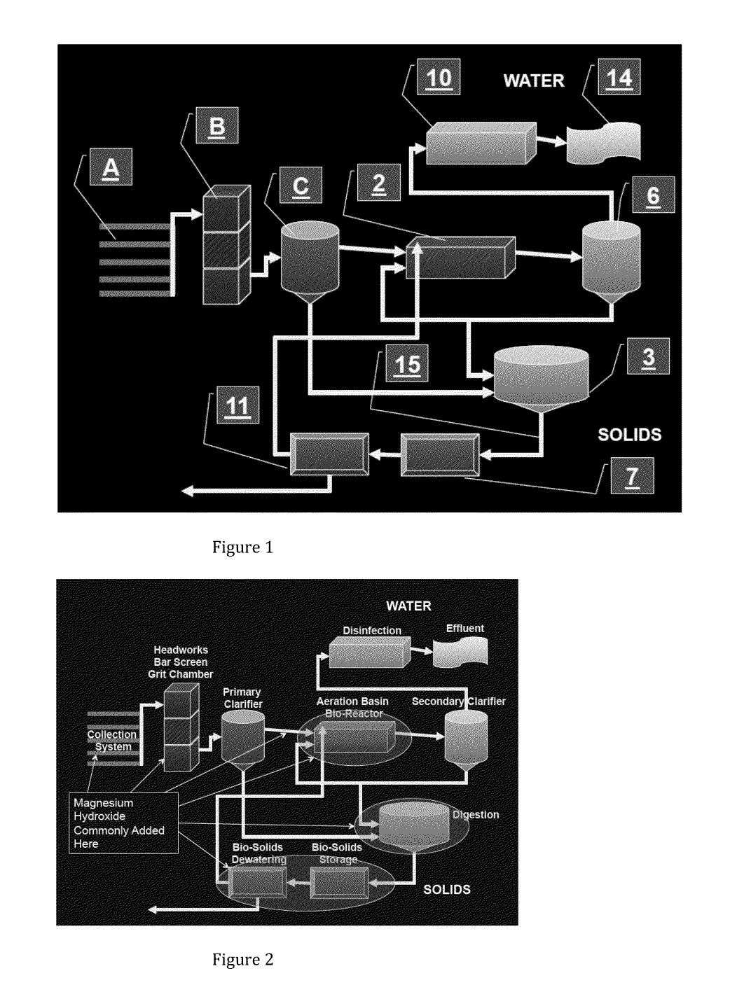

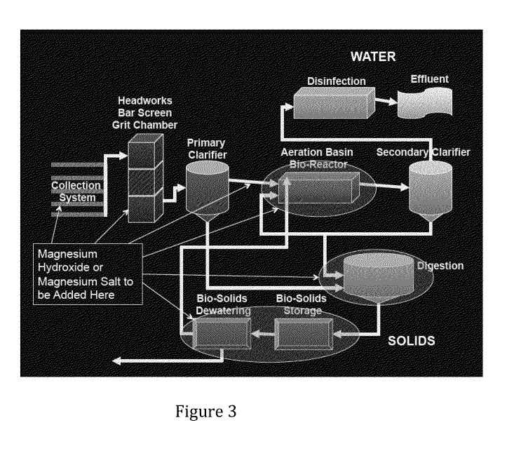

FIG. 1 is a schematic depiction of a wastewater collection and treatment system. A wastewater collection system is depicted by Box A in FIG. 1. The collection system typically consists of pipes, collection boxes, maintenance holes and pumping stations and commonly receives a mixture of wastes, from residential, commercial and industrial sources, which may contain various concentrations of organic constituents (commonly referred to as BOD-Biological Oxygen Demand or COD-Chemical Oxygen Demand), suspended solids and inorganic constituents. As a consequence of direct discharge from a residential, commercial or industrial source, or as a consequence of biological activity within the collection system, the collection system can itself be a source of nuisance odors, most commonly associated with H2S, though not exclusively, and nutrient loading, inclusive of organic Phosphorus-P and Nitrogen-N and inorganic phosphorus in the form of PO4-3, and inorganic nitrogen in the form of NO₃⁻¹ and NH₄⁺¹, to a wastewater treatment plant (WWTP). Mg(OH)₂ is commonly added in the collection system to reduce corrosion as well as H₂S and other organic odors, and to facilitate biological treatment of both P and N at the treatment plant.

Box B in FIG. 1 depicts the Headworks (HW) and Pre-Treatment (PT) Structures of a wastewater treatment plant. The HW and PT structures may include a plant influent pump station, grit removal, float removal and heavy grit separation among other processes. These structures are often sources of significant corrosion and odors as a result of turbulent conditions affecting influent wastewater. Mg(OH)2 is commonly added in the collection system to reduce corrosion, H2S and other organic odors generated at the HW and PT structures.

Box C in FIG. 1 depicts Primary Sedimentation/Settling/Clarification in a wastewater treatment plant.

Box 2 in FIG. 1 represents a biological reactor in a wastewater treatment plant. The biological reactor, commonly referred to as secondary treatment, can take on many forms inclusive of trickling filters, activated sludge basins-AS (conventional and extended air), sequential batch reactors—SBR, biological nutrient removal—BNR, enhanced nutrient removal—ENR, and enhanced biological phosphorus removal—EBPR. The processes may be aerobic, anoxic or anaerobic, or a combination of aerobic, anoxic and anaerobic, depending on the permit requirements for removal of BOD, TSS, NH3, NO3, TN, TKN, PO4-3, TP, and possibly other contaminants outlined in permits.

Box 6 in FIG. 1 represents Secondary Sedimentation/Settling/Clarification, designed to separate the biologically treated water from the microorganisms, (commonly referred to as biosolids) used to treat the contaminants.

Box 10 in FIG. 1 represents disinfection.

Box 14 in FIG. 1 represents the effluent outfall from a wastewater treatment plant and may contain various residual levels of the influent contaminants as regulated by the wastewater treatment plants discharge permits.

Box 3 in FIG. 1 represents digester stabilization of the biosolids, and may be, but not limited, aerobic or anaerobic digestion, the two most common methods of digester stabilization. The digestion process may also include heat exchangers

Box 7 in FIG. 1 represents sludge/biosolids storage of digested solids.

Box 11 in FIG. 1 represents biosolids processing, most typically, but not limited to, dewatering by drying beds, filter presses, or centrifuge.

Box 15 in FIG. 1 represents any piping, conveyance, pump, or any other method used to transfer solids, filtrate, centrate, supernatant, or concentrated liquor.

Typical residential wastewater streams contain the components of struvite (Mg⁺², NH₄⁺, and PO₄⁻³). Their concentrations are usually insufficient to precipitate struvite scale. However, the addition of industrial discharges that contain high levels of phosphate, ammonia or elevated pH may increase struvite potential within the collection system. In a system such as schematically illustrated in FIG. 1, the chemical potential for struvite formation is normally greatest in anaerobic digesters, sludge storage and sludge dewatering, where concentrations of Mg⁺², NH₄⁻, and PO₄⁻³ are typically highest. Problematic struvite scale more commonly occurs in or on transfer pipelines, pumps, valves, mixer blades, tanks walls, where physical factors such as turbulence triggers the localized pH swings that facilitate struvite scale formation.

A Mg(OH)₂ slurry can be, added in the collection system for odor or corrosion control. The addition of struvite seeds can mitigate the potential for struvite formation within the collection system, and in some locations at the wastewater treatment plant. The application of Mg(OH)₂ for odors and corrosion typically requires dosages between 1.0 and 10,0000 mg/L. The composition of struvite seed supplement depends upon the chemical equilibrium for struvite potential at the specified treatment locations.

In a wastewater treatment plant, the formation of struvite scale can occur in centrifuge dewatering facilities and the lines used to transport centrate. Struvite scale may also be found frequently in belt filter presses, filtrate lines, digesters, digested sludge holding tanks, sludge transport lines, pumps and valves. Within these plant processes, the occurrence of problematic struvite scale typically manifests where the existence of the components of struvite (Mg⁺², NH₄⁺ and PO₄⁻³) reach their highest concentrations, such as within an anaerobic digester and all storage, dewatering and sidestream biological systems downstream of the anaerobic digesters. The chemical and physical conditions for the occurrence of struvite scale may also exist elsewhere within a wastewater treatment plant, but to a lesser degree. The addition of struvite seeds to a Mg(OH)₂ slurry, which can be added in the collection system, or immediately upstream of these wastewater treatment processes, or added directly to these wastewater treatment processes, can mitigate the potential for struvite formation within each of these respective processes, inclusive of the digesters, dewatering facilities, sludge storage facilities and BNR processes.

In a wastewater treatment plant, the potential for problematic struvite scale will increase with the influx and implementation of BNR—Biological Nutrient Removal, EBPR—Enhanced Biological Phosphorus Removal, ENR—Enhanced Nutrient Removal and similar processes, as the amount of phosphorus that can be released in the digesters and downstream will increase as a function of increased biological phosphorus uptake. Struvite scale has been known to form in the anaerobic digesters, or downstream of the anaerobic digesters. In such a circumstance, Mg(OH)₂ may be added in the collection system. It can be seeded with struvite of specific size, so that the struvite seeds “settle” in the Primary Clarifiers and intermix with Primary sludge and are subsequently mixed with Secondary sludge before being processed by the digesters or transferred to sludge holding tanks The struvite seed composition, such as that can be added to the Mg(OH)₂ slurry depends upon the quantity necessary to reduce availability and concentration of struvite chemical components and to prevent scaling. In CAFO systems, the collection and treatment of waste streams is often mandated to reduce odor emissions and to prevent the pollution of surface and groundwater streams. Under conducive biological and chemical conditions, high concentrations nitrogen and phosphorus can contribute to struvite formation potential within the treatment processes and conveyance systems. When Mg(OH)₂ is added for odor control, or alkalinity supplements, in the CAFO waste treatment process, the slurry can be seeded with struvite crystals in order to prevent struvite scaling in pipes, pumps and basins. The struvite seed composition in the Mg(OH)₂ slurry shall be determined by quantity necessary to reduce availability and concentration of struvite chemical components and to prevent scaling.

In Landfills, Mg(OH)₂ may be used for odor control, pH adjustment, biological enhancement or metal capture. Under conducive biological and chemical conditions, high concentrations of nitrogen and phosphorus, under the right biological and chemical conditions can contribute to struvite formation potential within, for example, the leachate treatment processes and conveyance systems. When Mg(OH)₂ is added for odor control, metals reduction or alkalinity supplements, in the leachate treatment process, the slurry may be seeded with struvite crystals in order to prevent struvite scaling in pipes, pumps and basins. The struvite seed composition in the Mg(OH)₂ slurry shall be determined by quantity necessary to reduce availability and concentration of struvite chemical components and to prevent scaling.

A preferred embodiment of the present invention uses an admixture of Mg(OH)₂ and struvite seeds in various proportions applied to any or all of several processes as described. Other seeds of related magnesium phosphate chemistries can also be used, including, by way of non-limiting examples only, magnesium dihydrogen phosphate, magnesium diammonium phosphate, magnesium potassium phosphates and magnesium ammonium polyphosphate. Embodiments of the present invention may also use struvite or other seeds added to compositions including (1) Mg(OH)₂—blended with nitrates, (2) Mg(NO₃)₂ or other nitrate compounds, (3) Mg Ferrate or other ferrate compounds, or (4) Mg(OH)₂—blended with other compounds such as aluminates, ferrates, and polymers.

1. A method of treating wastewater comprising:
adding a magnesium compound to wastewater;
adding magnesium ammonia phosphate (Struvite) seeds to the wastewater.

2. The method according to claim 1, wherein the Struvite seeds have a size that is in the range of between approximately 5 millimeters and approximately 0.1 microns.

3. The method according to claim 1 wherein the magnesium compound comprises magnesium hydroxide (Mg(OH)₂) and wherein the concentration of the seeds is in the range of between approximately 0.1% and approximately 99% by weight of magnesium hydroxide (Mg(OH)₂) solids.

4. The method according to claim 3, wherein the concentration of magnesium hydroxide (Mg(OH)₂) is in the range of between approximately 1% and approximately 90% of the magnesium hydroxide (Mg(OH)₂) water slurry.

5. The method according to claim 3, further comprising:
adding at least one of the group consisting of a nitrate compound, a ferrate compound, and aluminates, ferrates, and polymers.

6. The method according to claim 1, wherein the magnesium compound comprises a magnesium nitrate compound, and the method further includes,
adding at least one of the group consisting of aluminates, ferrates, and polymers.
